(19) United States
(12) Patent Application Publication
(10) Pub. No.: US 2008/0021714 A1
(43) Pub. Date: Jan. 24, 2008

(54) Vehicle transportation tracking

(76) Inventors: Dennis A. Kraez, South Easton, MA (US); Robert A. Kraez, Framingham, MA (US); John H. O'Donnell, North Easton, MA (US)

Correspondence Address: FISH & RICHARDSON PC, P.O. BOX 1022, MINNEAPOLIS, MN, 55440-1022, US

(21) Appl. No.: 11/482,389

(22) Filed: Jul. 7, 2006

(51) Int. Cl. G06Q 10/00

(52) U.S. Cl. 705/1

(57) ABSTRACT

When transporting a vehicle, a hand-held wireless device is used to scan vehicle identifying information from the vehicle, information about the delivery is entered to the device, and the identifying information and the information about the transportation are sent to a server. The identifying information and the information about the transportation are received. Upon receiving the information, a record about the transportation is transmitted.

### BACKGROUND

This description relates to vehicle transportation tracking.

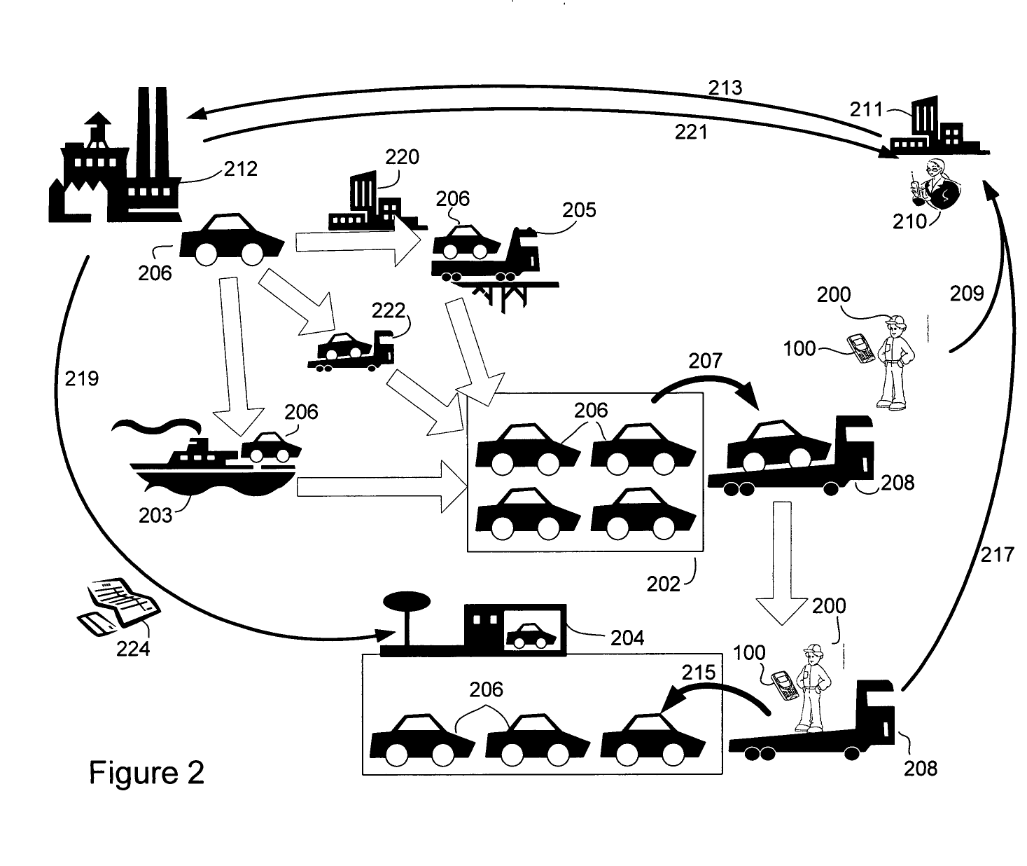

As shown in FIG. 2, in the course of transporting automobiles 206, for example, from an original equipment manufacturer (OEM) 212 to a dealer 204, the automobiles change hands multiple times. For example, the OEM 212 may turn the vehicles over to a rail company 220, which transports them by train 205 to a railhead 202, where they are turned over to a trucking company 211. Cars may also be transported by truck 222 or by ship 203 before, after, or instead of by rail. The trucking company 211 receives vehicles at the railhead, shipping port, or directly from the factory 212 and loads the vehicles onto trucks and hauls them to the dealership. At each stage, the party receiving the vehicles inspects them for damage and reports any damage found. If damage is found, the last party to handle a vehicle who didn't report the damage when taking possession is responsible for it. Once the dealer accepts a car, he can be invoiced by the manufacturer for the wholesale price.

Timely billing for the sale of vehicles is important to the manufacturer and dealer. In some examples, the manufacturer 212 transmits (219) a bill 224 to the dealer a fixed amount of time after handing the corresponding vehicle over to the rail company 220 or other shipper, based on the manufacturer's expectation of the time required to transport the vehicle to the dealer. The less delay between the time when the delivery occurs and the time when the invoice arrives at the dealer, the less interest expense is incurred by the manufacturer in financing the value of the cars.

### SUMMARY

In general, in one aspect, when transporting a vehicle, a hand-held wireless device is used to scan vehicle identifying information from the vehicle, information about the delivery is entered to the device, and the identifying information and the information about the transportation are sent to a server. The identifying information and the information about the transportation are received. Upon receiving the information, a record about the transportation is transmitted.

Implementations may include one or more of the following.

The identifying information includes a Vehicle Identification Number associated with the vehicle. Obtaining the identifying information includes scanning a bar code on the vehicle with a scanner in the device. Obtaining the identifying information includes receiving information from an RFID tag associated with the vehicle. The information about the transportation includes one or more of: information identifying damage to the vehicle, information identifying parts that the vehicle is missing, information describing inconsistencies between the vehicle and a description of the vehicle associated with the vehicle identifying information, an indication that the vehicle has been picked up for transportation, an identification of a dealership where the vehicle is to be or was delivered, an identification of a person who was present at a delivery, and information about whether the vehicle was inspected upon delivery. Transmitting the record includes transmitting information about the transportation of the vehicle to another party. After transmitting information to the other party, receiving payment from the other party for the transportation of the vehicle.

At a manufacturer, the record is received, a payment order is generated, and payment is rendered to a transporter of the vehicle. At a manufacturer, the record is received, and an invoice is generated and transmitted to a recipient of the vehicle. Generating the invoice includes: determining, from the information about the transportation, whether any adjustments should be made to an amount of money owed for the vehicle; determining the amount of money owed for the vehicle; and determining who is accountable for the amount of money. The record includes one or more of: information identifying the vehicle, information about damage to the vehicle, information about the transportation of the vehicle, and information about a delivery of the vehicle.

When delivering the vehicle, the hand-held wireless device is used to select the vehicle from a list provided by the device, information about exceptions is entered to the device, and the identifying information for the selected vehicle and the information about exceptions are sent to the server.

In general, in one aspect a device includes a wireless communications interface, a first input device including one or more of a bar code scanner and an RFID tag reader, a second input device, a display, a processor, and a memory. The memory contains instructions that cause the processor to: receive first data from the first input device that identifies a vehicle, interpret the first data as a vehicle identification number (VIN), retrieve information relating the VIN to information associated with the vehicle, display the VIN and the information on the display, receive second data from the second input device relating to the vehicle, and use the wireless communications interface to transmit the first and second data.

The wireless communications interface may include a radio configured to communicate using a cellular telephone data network, a radio configured to communicate using a satellite data network, a radio configured to communicate using a voice communications network, includes a radio configured to communicate using a wireless broadband network, or a radio configured to communicate using a wireless local area network.

In general, in one aspect, a computer readable medium contains instructions to cause a computer to receive from a first network interface first information including an identification of a vehicle and a destination, transmit on a second network interface at least a part of the first information, receive on the second network interface second information including an identification of the vehicle, an indication that the vehicle has been received for shipment, and an indication of whether the vehicle has any damage, receive on the second network interface third information including an identification of the vehicle and indication that the vehicle has been delivered, and transmit on the first network interface information including an indication that the vehicle has been delivered.

Advantages include facilitating rapid and accurate real-time invoicing for delivered vehicles. The parties involved in transporting vehicles may be informed about the status of the vehicle throughout the transportation and delivery process.

Other features and advantages of the invention will be apparent from the description and drawings, and from the claims.

### DESCRIPTION

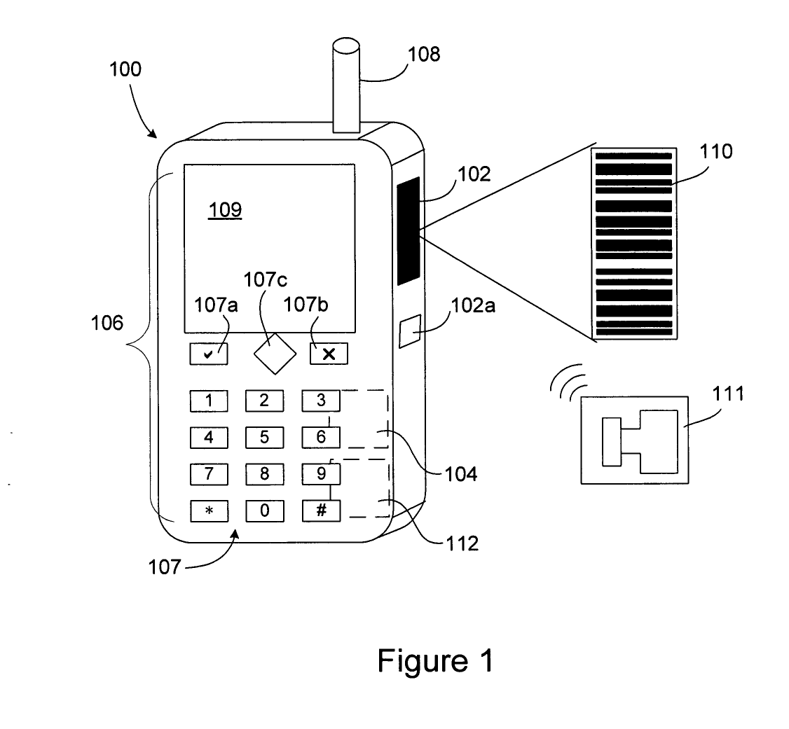

FIG. 1 is an isometric, partially schematic view of a hand-held wireless device.

FIGS. 2, 4, and 5 are block diagrams of a vehicle distribution network.

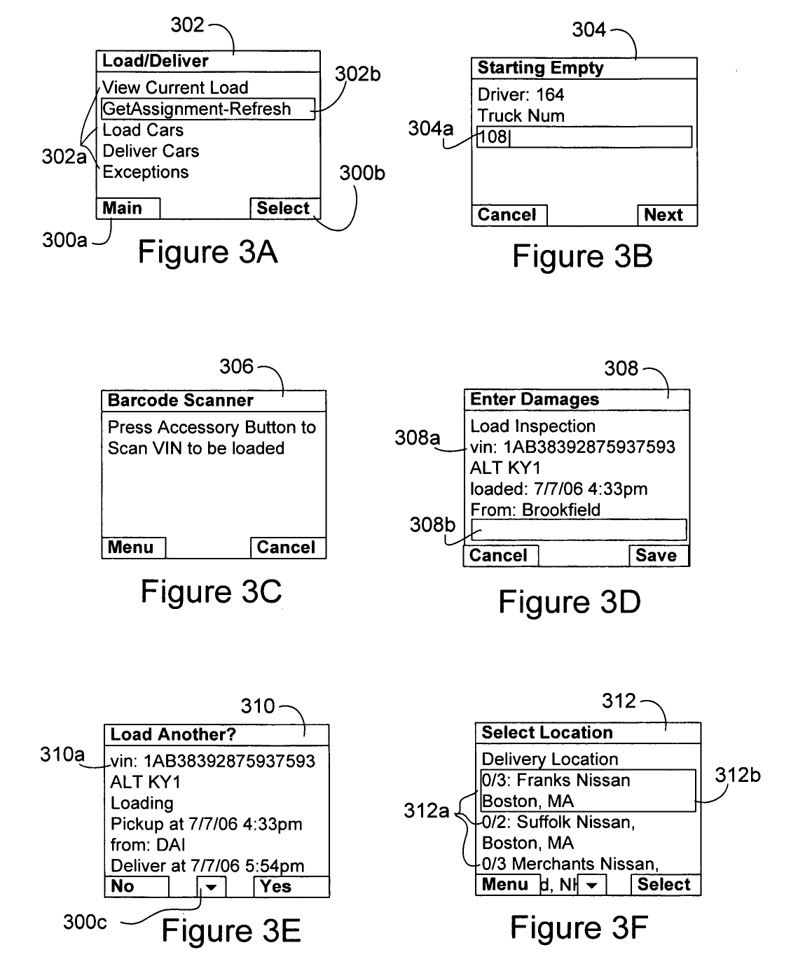

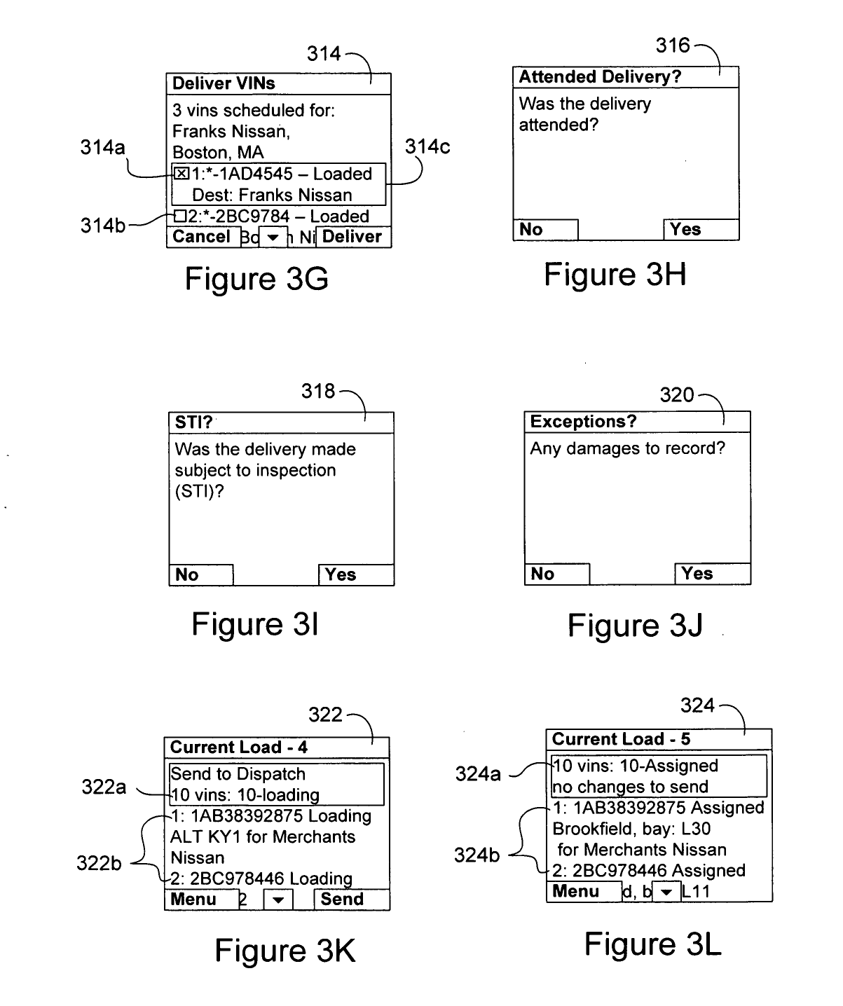

FIGS. 3A-3L are screens of a user interface.

To increase the accuracy and timeliness of information that is available about the transfer of vehicles along the way from the manufacturer or other source of the vehicle to a transporter, from one transporter to another, and ultimately from the final transporter to the destination of the vehicle, mobile devices can be used by truck drivers or other employees of the transporters (truck, rail, ship, or other) to obtain and report, in real time, information about the vehicles, their progress, damage that may have occurred during transportation, and information about paper or electronic documents associated with the delivery and sale of the vehicles. As described here, vehicles may include cars, trucks, tractors, construction equipment, or other similar products. Characteristics of such products may include high value and mobility (i.e., they can be driven away). Such products are frequently shipped without packaging, which increases the need to inspect for damage throughout the shipping process.

In some examples, as shown in FIG. 1, a hand-held device 100 is equipped with a scanner 102, a processor 104, a memory 112, a user interface 106, and a wireless communications interface 108. The scanner may be a bar code scanner, an RFID scanner, or some other device for obtaining identifying information from a vehicle. The wireless interface 108 may be an integrated cellular telephone for direct communication with a voice or data network, or it may be a short-range interface for communicating with a computer system located nearby, for example in a truck cab (see FIG. 2), which is in turn in communication with a voice or data network. The user interface 106 may be the usual interface of a mobile telephone, including a keypad with buttons 107 and a screen 109, or it may be a touch-screen or any other user interface commonly used in such devices. The interface is used, for example, for a user to input information about the status of the vehicles being transported, as described below. The memory may contain software for operating the device 100 and data for use in the operation of the device 100.

Bar codes 110 are attached to the vehicles to be shipped (see FIG. 2) and provide unique identifiers for the vehicles. In the example of an RFID-based system, RFID tags 111 could be located inside the vehicles, which has the advantage of preventing tampering. The bar codes or other identifying tags could encode the Vehicle Identification Number (VIN) or any other unique codes that identifies given vehicles. The bar codes may provide additional information as well, for example, an identification of the dealer who has ordered the vehicle and where the vehicle should be delivered. Vehicles are processed using the hand-held 100 at several points during the shipping process, as shown in FIG. 2. When the driver 200 who will be transporting vehicles from a distribution point 202 (e.g., a railhead or shipping port) to a delivery point 204 (e.g., a dealership) receives (207) vehicles 206 (e.g., from a ship 203 or train 205), he uses the scanner 102 (FIG. 1) of his hand-held 100 to scan the bar code 110 (FIG. 1), RFID tag 111, or other identification on each vehicle 206 he receives. Directly scanning a label or tag on or in the vehicle, rather than, for example, writing down the VIN to later enter into a terminal in the cab of the truck 208, has the advantage of increasing accuracy and assuring that the data is transmitted as rapidly as possible. It also allows more information to be read from a vehicle than would be reasonable in a pen-and-paper approach.

The user interface 106 confirms a successful scan and that each vehicle 206 scanned is indeed one the driver 200 should be receiving. In some examples, the hand-held 100 has a list in its memory 112 of vehicles the driver should receive and where they should be delivered. In some examples, the hand-held transmits each scanned identification to the shipping company 211 and the shipping company confirms that it is a vehicle that driver should receive and transmits delivery instructions to the hand-held 100. In some examples, there is no pre-determined assignment of vehicles to drivers, and the hand-held 100 simply downloads delivery instructions for whichever vehicles its driver 200 scans.

The user interface 106 then prompts the driver 200 to enter any information about damage to each vehicle 206, as discussed below. The driver inspects each vehicle carefully with a representative of the party that is turning over the vehicle, in some examples, to locate any damage or other problems. Besides physical damage to the vehicle, problems found in the inspection may include missing components or the vehicle not matching its description in some way, such as being the wrong color or even being the wrong model. After the driver 200 has loaded the vehicles 206 onto his truck 208, the hand-held 100 transmits the information (209) about the vehicles 204 just loaded to the driver's dispatcher 210 at the shipping company 211 or other interested parties. The shipping company 211 then notifies (213) the manufacturer 212 that the vehicle has been received from the distribution point 202 and is beginning its journey to its destination 204. The shipping company 211 also notifies the manufacturer of any damage identified by the driver 200 and entered into the hand-held 100. Although illustrated as a person, the dispatcher 210 could be a computer configured to receive information from the hand-held device 100 and associate it with stored information about vehicle shipments.

When the driver 200 has loaded all the vehicles 206 he is receiving for a given trip, he begins the drive to the delivery point 204. In some examples, the driver 200 uses the hand-held 100 to notify his dispatcher 210 that he has left the distribution point 202. In some examples, the hand-held is equipped with GPS or other location-based services, and notifies the dispatcher 210 of its location on its own. Upon reaching the destination 204, the driver unloads (215) the vehicles 206. As each vehicle 206 is unloaded, in some examples, the driver 200 manually selects the vehicle 206 from a list presented by the hand-held 100. In some examples, the driver 200 again scans the vehicle's bar code 110 rather than selecting the vehicle manually. After identifying the vehicle being delivered, the driver 200 uses the user interface 106 to enter any other relevant information. The dealership 204 receiving the vehicle 206 may inspect the vehicle itself, in case any damage arose during the last stage of shipping or wasn't found on earlier inspections. In some examples, the driver 200 indicates on his hand-held 100 that such an inspection took place, and my indicate who received the vehicle and conducted the inspection and any new damage that the dealer discovered. The dealership 204 may use the same or a similar system to log its receipt of the vehicle and any damage that is discovered in its own inspection.

After the driver 200 indicates that the vehicle has been delivered, the hand-held transmits (217) this information to the dispatcher 210, which in turn reports (213) the delivery to the manufacturer 212. The transmitting and reporting can be done in real time, that is, as soon as the information is available at each stage. This enables the manufacturer 212 to pay (221) the shipping company 211 and transmit (219) an invoice 224 electronically to the dealership 204 as soon as the vehicle is delivered. This is advantageous to the manufacturer 212 because it enables it to receive payment from the dealership 204 as soon as possible after the delivery has occurred, rather than attempting to predict the delivery time and possibly arguing with the dealer over when the vehicle was, or should have been, received, as might result from the processing of paper delivery reports and invoices. It is likewise advantageous to the dealership 204 because it does not receive the invoice before the vehicles are delivered. It is advantageous to the shipping company 211 because they get paid sooner than they would if paper forms had to be transmitted and processed. Both the manufacturer 212 and the dealership 204 can, if the shipping company 211 makes the information available to them, track the progress of the vehicles 206 and know when they will be delivered.

Logging any damage electronically is also advantageous, as it allows the manufacturer 212, dealership 204, and shipping company 211 to determine who is responsible for the damage contemporaneously with shipping and billing for the vehicle 206, rather than waiting for paper damage claims to make their way back up the chain to be settled while the invoice is waiting to be paid. For example, if the rail company is responsible for a dent in a vehicle's door, because the dent was not reported in the rail company's inspection at the factory and was reported in the driver's inspection at the rail yard, this information will be known to the manufacturer before the vehicle is delivered. The invoice can be generated as soon after the vehicle is delivered as the information about the delivery can be transmitted, and can account for the damage by, for example, reducing the amount owed by the dealer by the estimated cost of repairing the damage. (Manufacturers and their dealers often have fixed prices for standard repairs, which are not affected by the actual time or materials required in a specific instance.) The manufacturer can simultaneously inform the rail company that it will deduct a corresponding amount from its payment to the rail company, or it may file an appropriate claim with an insurance provider, depending on the details of the various party's contracts with each other. Since all of the information is transmitted electronically, and much of it is generated by machines, for example, by bar code readers, there will be fewer disputes between the parties about when damage or delivery occurred and who is responsible.

In some examples, the user interface 106 of the hand-held 100 is as shown in FIG. 3A-L. The driver 200 can provide input by pressing buttons on the device as prompted. In some screens, soft buttons 300a, 300b (only labeled in FIG. 3A) indicate the function to be performed by pressing a corresponding real button (107a, 107b in FIG. 1). This description will refer to the function of the button indicated by a soft button, not the physical button used to activate the soft button. When the information displayed extends beyond the screen, an arrow 300c (labeled in FIG. 3E) indicates that pressing the corresponding button (107c in FIG. 1) will scroll the text. Other user interface elements could be used, for example, providing scroll bars on the screen or a scroll wheel (not shown) in addition to buttons.

FIG. 3A shows a home screen 302 that a driver uses to select which activity 302a he needs to carry out. As indicated by a selection box 302b, the currently selected function is “Get Assignment-Refresh,” which causes the handheld device 100 to download a list of vehicles the driver should load onto his truck. If the driver has already begun scanning vehicles (described below), then this option discards any scanned information so that the driver can start fresh, for example, if he had scanned the wrong vehicles. The currently indicated option can be selected by choosing the “Select” soft button. Other available options 302a include “View Current Load,” which displays what vehicles are currently loaded (see FIGS. 3K and 3L), “Load Cars” and “Deliver Cars” which allow the driver to scan vehicles as they are loaded or unloaded (see FIGS. 3C, 3G), and “Exceptions,” which allows the driver to indicate problems or other issues (see FIG. 3E).

FIGS. 3B, 3C, 3D, and 3E show the process a driver uses when loading cars onto his truck. First, in a screen 304, the driver verifies his identity and verifies or updates the number of his truck in a text entry field 304a. Next, the hand-held prompts the driver, with a screen 306, to activate the bar code scanner 102 by pressing an accessory button 102a (FIG. 1). An audible tone may also be used to assist the driver in determining that the bar code has been scanned. A damage screen 308 displays the vehicle just scanned (308a) and gives the driver the opportunity to enter a damage code. The driver could enter a code manually in a text entry field 308b, using the numeric keypad 107 or from on-screen prompts (not shown). Other exceptions could also be entered at this point, for example, if a vehicle is missing parts (e.g., roof rack, antenna) or doesn't match the description associated with the VIN. A barcode scan confirmation screen 310 indicates the VIN 310a that was scanned and the associated information that was in the hand-held 100's memory 112 or was retrieved via its wireless communication interface 108. The driver indicates whether he wishes to scan another car using the appropriate soft button.

FIGS. 3F, 3G, 3H, 3I, and 3J show the process a driver uses when unloading cars at the dealership. First, in a location screen 312, the driver selects which dealership 312a he is at, indicated by a selection box 312b. This step may be performed automatically if the hand-held device 100 is equipped with or has access to GPS or other location-determining information. Next, a delivery screen 314 indicates which vehicles are to be delivered to the current dealership. For example, the “x” in a box 314a next to the first vehicle indicates that it is to be delivered, and the empty box 314b next to the second vehicle indicates that it is not to be delivered to the present dealership. The driver uses the “deliver” soft button to indicate that he has delivered the presently selected vehicle, indicated by a selection box 314c. Alternatively, the driver can use the bar code scanner 102 to scan each vehicle as it is unloaded, using screens similar to the screens 306 and 310 in FIGS. 3C and 3E. Scanning the vehicle bar code at the point of delivery may service as proof that the vehicle was delivered, useful to the various parties for timely billing. After the driver indicates that a vehicle has been delivered, query screens 316, 318, and 320 ask the driver specific questions, i.e., whether the delivery was attended (by dealership personnel), whether the delivery was subject to inspection (STI), and whether the driver has any exceptions to enter (such as damage during delivery).

Current load screens 322, 324, in FIGS. 3K and 3L, can be used by the driver to check on his current load of vehicles. The “loading” screen 322 indicates that the vehicles are in the process of being loaded, and offers to send that information to the driver's dispatcher. The “assigned” screen 324 indicates that the information has not changed since the last upload. The “vins” line 322a, 324b in each screen indicates how many vehicles are currently loaded, ten in this example. Other lines 322b, 324b indicate the details of those vehicles.

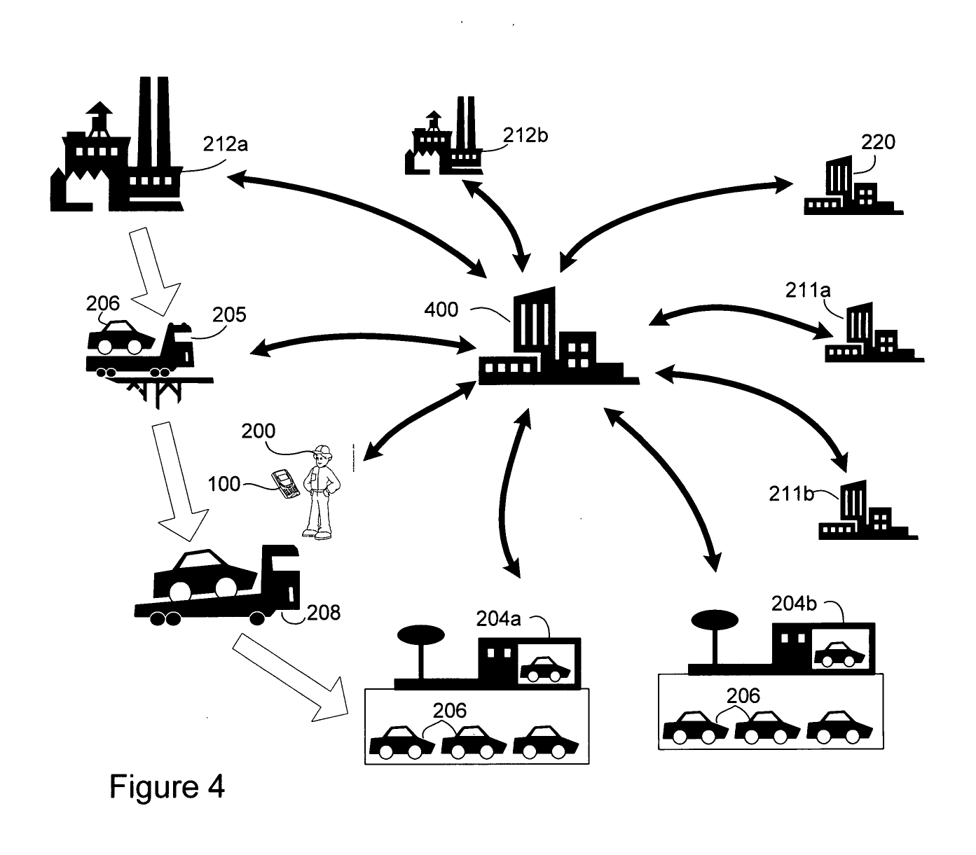

In some examples, as shown in FIG. 4, a third party logistics vendor 400 serves as an intermediary between the manufacturer 212 and shipping company 211. Different manufacturers 212a-b may use different proprietary protocols for communicating with shipping companies 211a-b and dealers 204a-b. Shipping companies that work with more than one manufacturer may prefer to exchange information with a single logistics vendor 400 rather than support the proprietary formats used by each of their manufacturer clients. The shipping companies 211a-b may also use proprietary data formats and tools, or may use formats and tools provided by the logistics vendor 400. In some examples, the hand-held devices 100 used by the drivers 200 communicate directly with the logistics vendor 400 which summarizes the information before sending it to the shipping companies. The logistics vendor 400 may also handle information from the dealers 204a-b and rail company 220, facilitating data exchange between any combination of the parties.

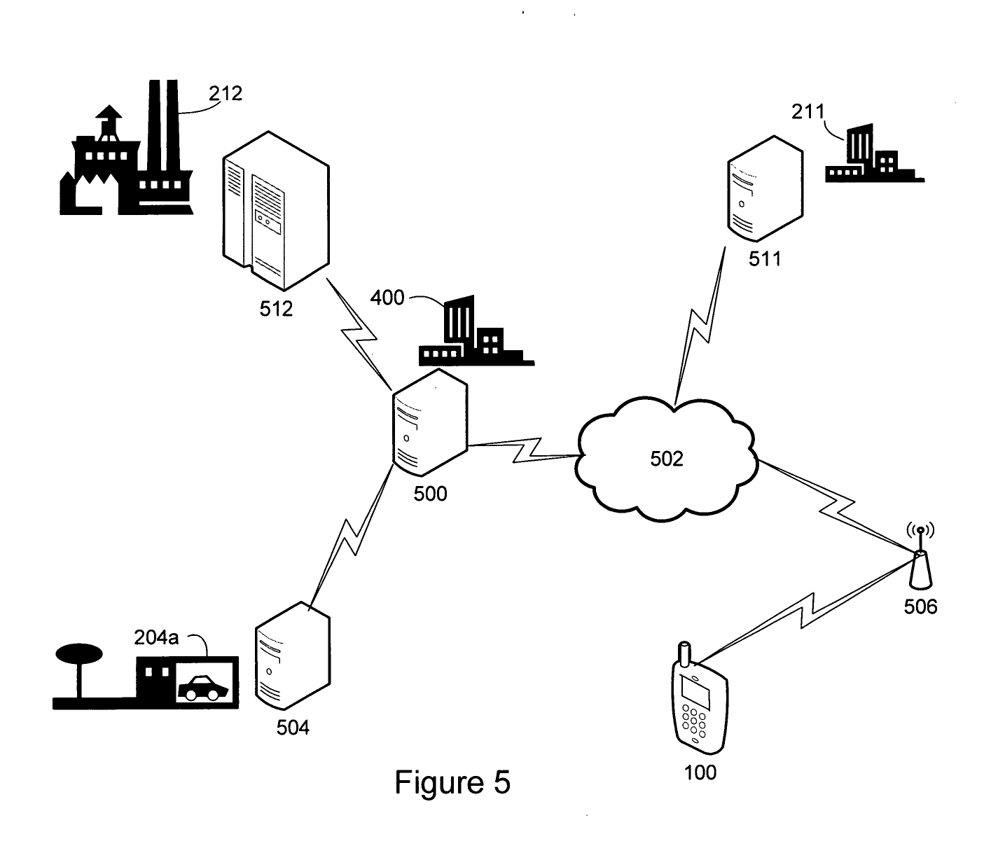

In some examples, the data flows over a combination of communications links and networks as shown in FIG. 5. A server 512 at the manufacturer 212 is in direct communication with a server 500 at the logistics vendor 400. A server 504 at the dealership 204 is also in direct communication with the logistics vendor's server 500. That server 500 is in communication with a server 511 at the shipping company 211 via the Internet 502. The hand-held device 100 communicates with a wireless telephone network 506, through which it reaches the Internet 502 and ultimately the logistics vendor's server 500. In some examples, the dealer's server 504 and manufacturer's server also communicate with the logistics vendor's server 500 over the internet 502, and in some examples the shipping company's server 511 is in direct communication with the logistics vendor's server 500. In examples where the manufacturer 212, dealer 204, or shipping company 211 communicate directly, without a logistics vendor or other intermediary, they could likewise have a direct connection or communicate through the Internet 502. The servers 500, 504, 511, 512 could each run any suitable operating system and be programmed in any suitable manner. They could all have the same or may all have different combinations of operating systems, software, and system architectures.

In some examples, each of the manufacturer 212, dealer 204, shipping company 211, and logistics vendor 400 have their own database for managing the data relevant to their operations. As information is exchanged between parties, it is formatted to interact with the receiving party's database and may be added to that database or may effect changes on the data already in the database. In some examples, one or more parties use the same database or copies of a single database. For example, the manufacturer 212 may have a master database of all vehicles it produces, while the dealer 204 has a copy of a subset of that database of the vehicles it has purchased. Information may be exchanged between the dealer and the manufacturer to keep those databases in sync. In some examples, only one party maintains the database, and other parties access it remotely as needed, for example, by transmitting a query and receiving results, or by transmitting transactions that represent changes to the database, and receiving confirmation that the change was or was not made. Each party may maintain an internal database and use a front-end system to interface their database to the databases of the other parties. The hand-held device 100 may include in its memory 112 a subset of either the logistics vendor's the shipper's database, so that the driver 200 may obtain information about the vehicles he is transporting even if he is temporarily separated from the telephone network 506.

Various network communications protocols could be used to exchange data between the various parties. Standard TCP/IP communications protocols, such as FTP or HTTP may be used, or proprietary protocols could be employed, or a combination. The communications could be encrypted, depending on the security needs of the parties and the security of the networks over which the data is transmitted. The telephone network 506 could be a wireless voice network or it could be a wireless data network. In some examples, the network 506 could be a satellite network. Various air interfaces and wireless protocols could be used, including analog cellular, GSM, EV-DO, or HSDPA. Local or wide area broadband networking technologies could also be used, such as Bluetooth, Wi-Fi (IEEE 802.11) or WiMax (IEEE 802.16). The hand-held 100 could be capable of using a variety of communications methods, and programmed to use the most efficient one in any given situation.

In some examples, parties other than manufacturers and dealers may originate or receive shipments of vehicles. Auto auctions may both ship and receive large numbers of new and used vehicles. A dealer may purchase cars at an auction and then engage a shipping company directly to transport the cars to the dealer's lot. Dealers may ship cars between each other, for example, if a buyer wants a vehicle with certain options that his dealer doesn't have in stock, that dealer may prefer to swap a car with another dealer rather than order a new car from the manufacturer. In some examples, retail buyers may be able to access the information, for example, to track the status of vehicles they have ordered through their dealer.

Other embodiments are within the scope of the following claims.

What is claimed is:

1. A method comprising:
when transporting a vehicle, using a hand-held wireless device to
scan vehicle identifying information from the vehicle,
enter to the device information about the transportation, and
send the identifying information and the information about the transportation to
a server;
receiving the identifying information and the information about the transportation; and
upon receiving the information, transmitting a record about the transportation.

2. The method of claim 1 in which the identifying information comprises a Vehicle Identification Number associated with the vehicle.

3. The method of claim 1 in which obtaining the identifying information comprises scanning a bar code on the vehicle with a scanner in the device.

4. The method of claim 1 in which obtaining the identifying information comprises receiving information from an RFID tag associated with the vehicle.

5. The method of claim 1 in which the information about the transportation comprises one or more of: information identifying damage to the vehicle, information identifying parts that the vehicle is missing, information describing inconsistencies between the vehicle and a description of the vehicle associated with the vehicle identifying information, an indication that the vehicle has been picked up for transportation, an identification of a dealership where the vehicle is to be or was delivered, an identification of a person who was present at a delivery, and information about whether the vehicle was inspected upon delivery.

6. The method of claim 1 in which transmitting the record comprises:
transmitting information about the transportation of the vehicle to another party.

7. The method of claim 6 also comprising:
after transmitting information to the other party, receiving payment from the other party for the transportation of the vehicle.

8. The method of claim 1 also comprising:
at a manufacturer,
receiving the record; and
generating a payment order and rendering payment to a transporter of the vehicle.

9. The method of claim 1 also comprising:
at the manufacturer,
receiving the record; and
generating an invoice and transmitting the invoice to a recipient of the vehicle.

10. The method of claim 9 in which generating the invoice comprises:
determining, from the information about the transportation, whether any adjustments should be made to an amount of money owed for the vehicle;
determining the amount of money owed for the vehicle; and
determining who is accountable for the amount of money.

11. The method of claim 1 in which the record comprises one or more of: information identifying the vehicle, information about damage to the vehicle, information about the transportation of the vehicle, and information about a delivery of the vehicle.

12. The method of claim 1 also comprising:
when delivering the vehicle, using the hand-held wireless device to select the vehicle from a list provided by the device,
enter to the device information about exceptions, and
send the identifying information for the selected vehicle and the information about exceptions to the server.

13. The method of claim 1 in which the hand-held wireless device comprises a wireless telephone.

14. An apparatus comprising:
a wireless communications interface,
a first input device comprising one or more of a bar code scanner and an RFID tag reader,
a second input device,
a display,
a processor, and
a memory;
in which the memory contains instructions that cause the processor to:
receive first data from the first input device that identifies a vehicle,
interpret the first data as a vehicle identification number (VIN),
retrieve information relating the VIN to information associated with the vehicle,
display the VIN and the information on the display,
receive second data from the second input device relating to the vehicle, and
use the wireless communications interface to transmit the first and second data.

15. The apparatus of claim 14 in which the wireless communications interface comprises a radio configured to communicate using a cellular telephone data network.

16. The apparatus of claim 14 in which the wireless communications interface comprises a radio configured to communicate using a satellite data network.

17. The apparatus of claim 14 in which the wireless communications interface comprises a radio configured to communicate using a voice communications network.

18. The apparatus of claim 14 in which the wireless communications interface comprises a radio configured to communicate using a wireless broadband network.

19. The apparatus of claim 14 in which the wireless communications interface comprises a radio configured to communicate using a wireless local area network.

20. A computer readable medium containing instructions to cause a computer to
receive from a first network interface first information comprising an identification of a vehicle and a destination,
transmit on a second network interface at least a part of the first information,
receive on the second network interface second information comprising an identification of the vehicle, an indication that the vehicle has been received for shipment, and an indication of whether the vehicle has any damage,
receive on the second network interface third information comprising an identification of the vehicle and indication that the vehicle has been delivered, and
transmit on the first network interface information comprising an indication that the vehicle has been delivered.
